(19) United States
(12) Patent Application Publication
(10) Pub. No.: US 2025/0046899 A1
(43) Pub. Date: Feb. 6, 2025

(54) METHOD FOR MANUFACTURING BATTERY MATERIAL

(71) Applicants: Prime Planet Energy & Solutions, Inc., Tokyo (JP); THE UNIVERSITY OF TOKYO, Tokyo (JP)

(72) Inventors: Shinya SUZUKI, Kobe-shi (JP); Takanari OUCHI, Tokyo (JP)

(21) Appl. No.: 18/788,130

(22) Filed: Jul. 30, 2024

(30) Foreign Application Priority Data
Aug. 3, 2023 (JP) 2023-126804

(51) Int. Cl. H01M 10/54; C22B 3/00; C22B 7/00; C22B 15/00; C22B 23/02

(52) U.S. Cl. CPC H01M 10/54; C22B 7/001; C22B 7/007; C22B 15/0056; C22B 15/0067; C22B 23/02; C22B 23/0415

(57) ABSTRACT

A manufacture method disclosed herein includes: a preparation step S11 of preparing a recovery object; a measurement step S12 of measuring a quantity of oxygen element and a reducing component contained in the recovery object; a determination step S13 of determining whether or not a quantity ratio of the reducing component relative to oxygen element is higher than or equal to a threshold value based on a stoichiometric ratio of an oxide of the reducing component; a reducing component addition step S14 of adding the reducing component to the recovery object when a determined result value in the determination step is lower than the threshold value; and a heating step S15 of heating the recovery object under an inert atmosphere. This method makes it possible to reduce the valuable metal into an elemental metal, and therefore a valuable metal recovery efficiency can be improved.

### CROSS REFERENCE TO RELATED APPLICATION

This application claims priority based on Japanese Patent Application No. 2023-126804 filed Aug. 3, 2023, the entirety of which is herein incorporated by reference.

### BACKGROUND OF THE DISCLOSURE

### 1. Field

The technology disclosed herein relates to a method for manufacturing a battery material.

### 2. Background

Lithium ion secondary batteries are widely used in various fields. Various materials including valuable metals such as Ni and Co are used for these lithium ion secondary batteries. For example, as positive electrode active materials, lithium transition metal composite oxides are used, such as lithium-nickel composite oxides, lithium-cobalt composite oxides, lithium-nickel-cobalt composite oxides, and lithium-nickel-cobalt-manganese composite oxides. Aluminum and the like are used for a positive electrode core. On the other hand, carbon materials and the like are used for a negative electrode active material. Copper and the like are used for a negative electrode core. Furthermore, aluminum and the like are also used for battery cases for accommodating these electrodes.

In recent years, development of recovery technologies has been promoted to recover valuable metals from used batteries, process end materials, and the like to reuse them as battery materials. In this recovery technology, a recovery object (used batteries, process end materials, etc.) is first roasted. Then, the roasted recovery object is subjected to acid exudation. This makes it possible to dissolve metal components (Li, Ni, Co, Mn, Al, Cu, etc.) in the recovery object in an acid liquid to obtain a metal solution. Also, this acid exudation makes it possible to separate carbon components from the recovery object. On the other hand, the metal solution after the acid exudation is subjected to various separation treatments (neutralization deposition, solvent extraction, etc.). Thereby, desired metal components can be extracted and reused as battery materials.

An example of this recovery technology is disclosed in Japanese Patent No. 2022-118594. In the recovery method described in this literature, a battery slag (recovery object) including a positive electrode active material containing Ni and/or Co and a negative electrode active material containing a graphite is heated in a heating step (roasting step), to oxidize the graphite contained in the negative electrode active material in the battery slag to produce carbon dioxide gas. In this recovery method, the recovery object is roasted under an oxidizing atmosphere (e.g. ambient atmosphere). Thereby, valuable metals (trivalent or tetravalent Ni ions and Co ions) in the recovery object are reduced into divalent oxides. This literature suggests that such divalent oxides are easily dissolved in an acid liquid in the acid exudation step.

### SUMMARY

However, as a result of investigations, the present inventors have found that the above-described divalent oxides of valuable metals are still poor in acid liquid-solubility. If acid-solubility of valuable metals is low, not only valuable metals but also a large amount of other metal materials (Cu etc.) may dissolve in a metal solution after acid exudation. This results in not only complicated impurity separation treatment but also partial removal of the valuable metals during the separation treatment.

To resolve the above problems, a method for manufacturing a battery material having a configuration described below (hereinafter simply referred to as “manufacture method”) is provided.

The method for manufacturing the battery material disclosed herein includes: a preparation step of preparing a recovery object containing at least one of Ni and Co; a measurement step of measuring a quantity of oxygen element and a quantity of a reducing component contained in the recovery object; a determination step of determining whether or not a quantity ratio of the reducing component relative to oxygen element is higher than or equal to a threshold value based on a stoichiometric ratio of an oxide of the reducing component; a reducing component addition step of adding the reducing component to the recovery object when a determined result value in the determination step is lower than the threshold value; and a heating step of heating the recovery object under an inert atmosphere.

In the manufacture method having the above configuration, the recovery object is roasted under a state wherein the recovery object contains a large amount of the reducing component and no oxygen element is fed from the outside. Thereby, the transfer of oxygen element from oxides of valuable metals (hereinafter also referred to as “valuable metal oxides”) in the recovery object to the reducing component can be rapidly enhanced. As a result, the valuable metals in the recovery object can be reduced into elemental metals. The elemental metals of the valuable metals have an acid-solubility superior to that of other metal materials, contributing to a significant improvement of the valuable metal recovery efficiency.

### BRIEF DESCRIPTION OF THE DRAWINGS

FIG. 1 is a schematic longitudinal sectional view of an internal structure of a lithium ion secondary battery;

FIG. 2 is a schematic perspective view of an electrode body of the lithium ion secondary battery illustrated in FIG. 1;

FIG. 3 is a flowchart illustrating a method for manufacturing a battery material according to an embodiment;

FIG. 4 is a flowchart illustrating a roasting step in a manufacture method according to an embodiment in detail;

FIG. 5 is a flowchart illustrating a solvent extraction step in a manufacture method according to an embodiment in detail; and

FIG. 6 is a diagram presenting a result of an XRD analysis in a test example.

### DETAILED DESCRIPTION OF THE PREFERRED EMBODIMENTS

Hereinafter, an embodiment of a technology disclosed herein will be explained with reference to the figures. Matters other than those specifically mentioned in this specification, which are necessary for implementing the technology disclosed herein may be understood as design matters for those skilled in the art, based on the prior art in the field. The technology disclosed herein can be implemented based on the contents disclosed in this specification and the general technical knowledge in the field.

### 1. Recovery Object

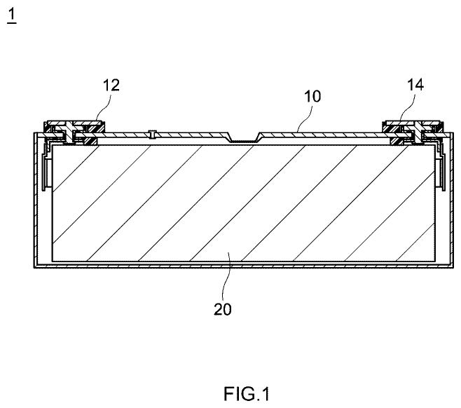

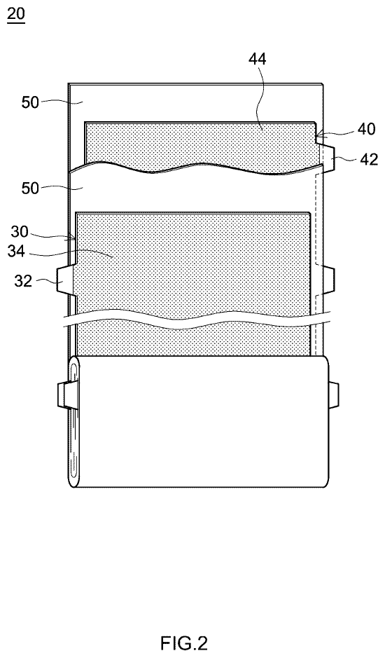

In the method for manufacturing the battery material according to this embodiment, a battery material (typically, a material for a positive electrode active material of lithium ion secondary batteries, a precursor of a positive electrode active material, and a positive electrode active material) is manufactured by recovering valuable metals such as Ni and Co from a given recovery object. Herein, an example of the recovery object is a used lithium ion secondary battery. This lithium ion secondary battery will be specifically explained below. FIG. 1 is a schematic longitudinal sectional view of an internal structure of a lithium ion secondary battery. FIG. 2 is a schematic perspective view of an electrode body of the lithium ion secondary battery illustrated in FIG. 1.

As illustrated in FIG. 1, a lithium-ion secondary battery 1 includes a case 10, an electrode body 20, and an electrolyte (illustration omitted).

### (1) Case

The case 10 is a box-like container. The case 10 accommodates the electrode body 20 and the electrolyte. For the case 10, e.g. a metal material having a certain strength (aluminum (Al) etc.) is used. Also, a positive electrode terminal 12 and a negative electrode terminal 14 are attached to the case 10. The positive electrode terminal 12 and the negative electrode terminal 14 are connected to the electrode body 20 inside the case 10. Specifically, the positive electrode terminal 12 is connected to a positive electrode plate 30 (see FIG. 2) of the electrode body 20. For this positive electrode terminal 12, aluminum (Al) or the like is used. On the other hand, the negative electrode terminal 14 is connected to the negative electrode plate 40 of the electrode body 20. For this negative electrode terminal 14, copper (Cu) or the like is used.

### (2) Electrode Body

The electrode body 20 is a power generating element of the lithium ion secondary battery 1. As illustrated in FIG. 2, the electrode body 20 includes the positive electrode plate 30, the negative electrode plate 40, and a separator 50. The electrode body 20 illustrated in FIG. 2 is a wound electrode body. This wound electrode body is fabricated by laminating the positive electrode plate 30, the negative electrode plate 40, and the separator 50 to form an elongated belt-like laminate and then winding the laminate. However, the structure of the electrode body 20 is not particularly limited, and the electrode body 20 may have another conventionally known structure (laminated electrode body etc.).

The positive electrode plate 30 includes a positive electrode core 32 that is a conductive metal foil, and a positive electrode active material layer 34 provided on a surface of the positive electrode core 32. For the positive electrode core 32, aluminum (Al) or the like is used. The positive electrode active material layer 34 is a composite material layer including a positive electrode active material, a conductive material, a binder, and the like. The positive electrode active material is a lithium transition metal composite oxide containing at least one of nickel (Ni) and cobalt (Co). Examples of this lithium transition metal composite oxide include a lithium-nickel composite oxide, a lithium-cobalt composite oxide, a lithium-nickel-manganese composite oxide, a lithium-manganese-cobalt composite oxide, a lithium-nickel-cobalt composite oxide, and a lithium-nickel-manganese-cobalt composite oxide. The manufacture method according to this embodiment makes it possible to efficiently recover Ni and/or Co from a recovery object containing such a lithium transition metal composite oxide. Examples of the conductive material include carbon materials such as acetylene black and graphite. Examples of the binder include resin materials such as polyvinylidene fluoride (PVdF).

On the other hand, the negative electrode plate 40 has a negative electrode core 42 that is a conductive metal foil, and a negative electrode active material layer 44 provided on a surface of the negative electrode core 42. For the negative electrode core 42, copper (Cu) or the like is used. The negative electrode active material layer 44 is a composite material layer containing a negative electrode active material, a binder, a thickener, and the like. Examples of the negative electrode active material include carbon materials such as black lead, hard carbon, and soft carbon. Other examples of the negative electrode active material include lithium titanate (LTO), silicon carbide, a composite containing carbon and silicon, and silicon oxide (SiO_{X}). As described in detail below, the manufacture method according to this embodiment makes it possible to properly improve the valuable metal recovery efficiency even if a recovery object is a battery using such a non-carbon negative electrode active material. Examples of the binder include resin materials such as styrene-butadiene rubber (SBR). Examples of the thickener include resin materials such as carboxymethylcellulose (CMC).

The separator 50 is an insulating sheet interposed between the positive electrode plate 30 and the negative electrode plate 40. For this separator 50, e.g. a resin material such as polyethylene (PE), polypropylene (PP), polyester, cellulose, and polyamide is used. A heat-resistant layer including an inorganic filler may be formed on the surface of the separator 50. Examples of the inorganic filler include inorganic oxides such as aluminum oxide, magnesium oxide, silicon oxide, and titanium oxide; nitrides such as aluminum nitride and silicon nitride; metal hydroxides such as calcium hydroxide, magnesium hydroxide, and aluminum hydroxide; as well as clay minerals such as mica, talc, boehmite, zeolite, apatite, and kaolin.

### (3) Electrolyte

The electrolyte is interposed between the positive electrode plate 30 and the negative electrode plate 40. Thereby, charge carriers (Li ions) can be transferred between the positive electrode plate 30 and the negative electrode plate 40. Examples of the electrolyte include a nonaqueous electrolytic solution and a gel electrolyte. As the electrolyte, an electrolyte usable in a lithium ion secondary battery can be used without any particular limitation, and the technology disclosed herein is not limited.

As described above, the lithium ion secondary battery 1 has been explained as an example of the recovery object in the manufacture method according to this embodiment. However, the manufacture method disclosed herein is not limited to the method using, as a recovery object, the lithium ion secondary battery 1 having the above configuration. For example, when fabricating an electrode body at a manufacture site of lithium ion secondary batteries, a part of a positive electrode plate is cut out in some cases. This cut part (process end material) of the positive electrode plate also contains Ni and Co and therefore can be a recovery object in the manufacture method disclosed herein. Furthermore, at the manufacture site of lithium ion secondary batteries, some defects may occur on fabricated electrode bodies, and therefore the electrode bodies cannot be used for products in some cases. Such an electrode body also contains Ni and Co and therefore may be used as a recovery object. That means, the recovery object in the manufacture method disclosed herein is not limited to a particular structure as long as the recovery object contains at least one of Ni and Co.

### 2. Method for Manufacturing Battery Material

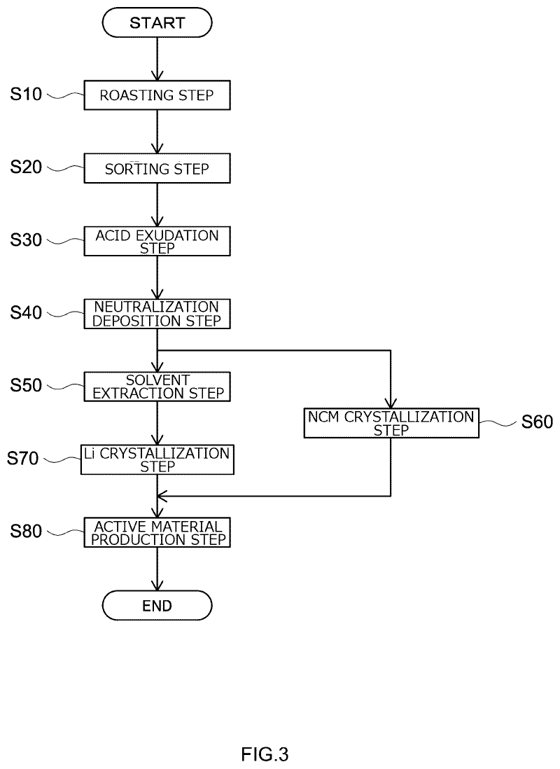

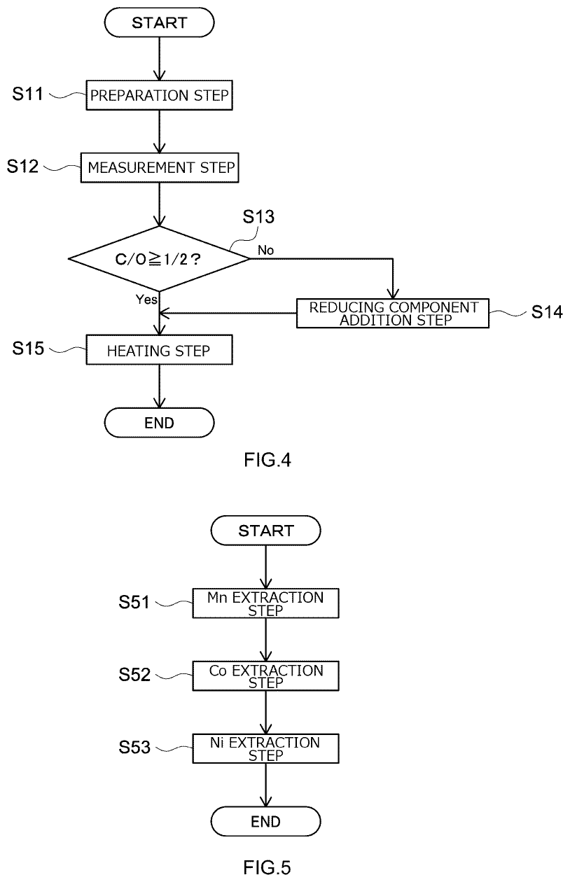

A method for manufacturing the battery material according to this embodiment will be explained below. FIG. 3 is a flowchart illustrating the manufacture method according to this embodiment. FIG. 4 is a flowchart illustrating a roasting step in FIG. 3 in detail. FIG. 5 is a flowchart illustrating a solvent extraction step in FIG. 3 in detail.

As illustrated in FIG. 3, the method for manufacturing the battery material according to this embodiment includes a roasting step S10, a sorting step S20, an acid exudation step S30, a neutralization deposition step S40, a solvent extraction step S50, a nickel-cobalt-manganese (NCM) crystallization step S60, a Li crystallization step S70, and an active material production step S80. Each step will be explained below.

### (1) Roasting Step S10

In this step, a recovery object is heated at a predetermined temperature. This makes it possible to remove liquid components (electrolytic solution etc.) in the recovery object and to carbonize resin components (binder, separator, etc.). When the charged lithium ion secondary battery 1 is used as a recovery object, the battery function can be deactivated by conducting the roasting step S10. Thereby, the subsequent steps can be conducted safely.

As illustrated in FIG. 4, the roasting step S10 in this embodiment includes a preparation step S11, a measurement step S12, a determination step S13, a reducing component addition step S14, and a heating step S15. Thereby, the recovery efficiency of valuable metals such as Co and Ni can be significantly improved. Each step will be specifically explained below.

### (a) Preparation Step S11

In this step, a recovery object containing at least one of Ni and Co is prepared. As described above, the “recovery object” in the technology disclosed herein is not limited to completed lithium ion secondary batteries but includes process end materials and defective parts (electrode body etc.). Since the details of the recovery object have been already explained above, repeated explanations are omitted. The manufacture method according to this embodiment makes it possible to recover (manufacture) not only nickel (Ni) and cobalt (Co) described above but also manganese (Mn), lithium (Li), and the like.

### (b) Measurement Step S12

In the measurement step S12, quantities of oxygen element (O) and a reducing component contained in the recovery object are measured. In this step, a part of the recovery object should be taken as a measurement sample to measure oxygen element and the reducing component in the measurement sample. This step should be conducted only when a type of the recovery object is changed, and is not necessarily conducted for all prepared recovery objects. Thus, the producibility cam be improved.

The “reducing component” in this specification is not particularly limited as long as the component can reduce Ni and Co in the heating step S15 described below. In the manufacture method according to this embodiment, carbon element (C) is used as a reducing component. Carbon is particularly preferable as a reducing component because it is stable and is hardly oxidized until the heating step S15 is started. Some types of recovery objects contain various carbon materials (conductive material, binder, negative electrode active material, etc.). Use of these carbon materials as a source of the reducing component contributes to decrease in the cost required for recovering valuable metals.

The means for measuring the quantity of the reducing component (carbon element) in the recovery object is not particularly limited, and any conventionally known measurement means can be used without any particular limitation. Examples of the means for measuring the quantity of carbon element include a thermogravimetric-differential thermal analysis (TG-DTA), a scanning electron microscope-energy dispersive X-ray spectroscopy (SEM-EDS) analysis, an oxygen stream combustion-nondispersive infrared analysis method, and a combustion capacity method.

Next, the means for measuring the quantity of oxygen element in the recovery object will be explained. If the chemical composition of the positive electrode active material in the recovery object is known in advance, a quantity of metal elements in the recovery object should be measured to calculate a quantity of oxygen element based on the quantity of the metal elements. Thereby, the quantity of oxygen element in the valuable metal oxide (e.g. lithium transition metal composite oxide) can be easily measured. A specific example of this measurement procedure is as follows. First, a part of the recovery object (measurement sample) is dissolved in an acid to prepare a solution. Subsequently, this solution is subjected to an inductively coupled plasma (ICP) analysis. This analysis makes it possible to measure the total quantity M of transition metal elements (Ni, Co, and Mn) in the recovery object. If the chemical composition (LiNiₓCo_{y}Mn_{z}O_{δ}) of the positive electrode active material in the recovery object is known, a ratio of the total quantity of the transition metal elements (x+y+z) relative to the quantity of O(δ)(x+y+z:δ) can be determined. In this case, a quantity N of oxygen element can be calculated from the ICP measurement result (total quantity M of metal elements) based on the following Equation (1).

$$N = δ \cdot M / ( x + y + z ) \qquad ( 1 )$$

The means for measuring the quantity of oxygen element in the recovery object is not limited to the means described above, and any conventionally known measurement means can be adopted without any particular limitation. For example, an SEM-EDS analysis, an X-ray fluorescence (XRF) analysis, or the like may be used to directly measure oxygen element in the recovery object. Use of these methods makes it possible to measure the quantity of oxygen element even if the chemical composition of the positive electrode active material in the recovery object is unknown.

### (c) Determination Step S13

In the determination step S13, it is determined whether or not the quantity ratio of the reducing component relative to oxygen element is higher than or equal to a predetermined threshold value. Herein, the “threshold value” in this step is set based on a stoichiometric ratio of the oxide of the reducing component. For example, when carbon element is used as the reducing component, the above-described “oxide of the reducing component” is carbon dioxide (CO₂). In this case, in order to properly reduce the oxides of the valuable metals in the heating step S15 described later, the threshold value is set to a value higher than or equal to a ratio of carbon element relative to oxygen element in CO₂ (1/2). Then, in this step, it is determined whether or not the quantity ratio of carbon element (reducing component) relative to oxygen element (C/O ratio) in the recovery object is 1/2 or higher. This makes it possible to determine whether or not the recovery object contains the reducing component in an amount sufficient for reducing the valuable metals into elemental metals. If the C/O ratio is higher than or equal to 1/2 (“YES” in S13 of FIG. 4), the recovery object is subjected to the heating step S15. On the other hand, if the C/O ratio is lower than 1/2 (“NO” in S13 of FIG. 4), the recovery object is subjected to the reinducing component addition step S14.

As described above, the threshold value in this step may be set to a value higher than or equal to the stoichiometric ratio of the oxide of the reducing component. For example, when the reducing component is carbon element, the threshold value may be set to higher than or equal to 3/4 (more preferably higher than or equal to 1, even more preferably higher than or equal to 5/4, and particularly preferably higher than or equal to 3/2). Thus, only the recovery object containing a large amount of reducing component (carbon element) can be subjected to the heating step S15, and therefore reduction of the valuable metal oxides can be further enhanced in the heating step S15.

### (d) Reducing Component Addition Step S14

In the reinducing component addition step S14, if the determined result in the determination step S13 is lower than the threshold value (“NO” in S13 of FIG. 4), the reducing component is added to the recovery object. In this embodiment, if the recovery object is determined to have a C/O ratio lower than 1/2 in the determination step S13, the reducing component (carbon-containing material) is added to the recovery object such that the C/O ratio is higher than or equal to the threshold value (1/2 or higher). Thereby, the recovery object can contain the reducing component (carbon element) in an amount sufficient for reducing the valuable metals into elemental metals. Herein, examples of the carbon-containing material include black lead, hard carbon, soft carbon, and other carbon materials. The carbon-containing material may also be a resin material such as polyolefin and polyester. These resin materials can be used as a source of carbon element because they carbonize to produce carbon element at the early stage of the heating step S15.

In this step, the reducing component may be added in an amount significantly larger than the above-described threshold value. For example, when the reducing component is carbon element, the carbon-containing material may be added such that the C/O ratio in the recovery object is 3/4 or higher (more preferably 1 or higher, even more preferably 5/4 or higher, particularly preferably 3/2 or higher). Thus, the recovery object containing a large amount of reducing component (carbon element) can be subjected to the heating step S15, and therefore reduction of the valuable metal oxides can be further enhanced in the heating step S15.

### (e) Heating Step S15

In the heating step S15, the recovery object is heated under an inert atmosphere. In the manufacture method according to this embodiment, the recovery object with a reducing component quantity ratio relative to oxygen element, adjusted to a value higher than or equal to the stoichiometric ratio of the oxide of the reducing component, is subjected to the heating step S15. That means, the recovery object in this embodiment is heated while containing a large amount of reducing component. Furthermore, in the heating step S15 according to this embodiment, the recovery object is heated under an inert atmosphere. This prevents oxygen element from being fed to the recovery object during heating. As a result, rapid transfer of oxygen element from valuable metal oxides (lithium transition metal composite oxides etc.) to the reducing component can be enhanced. For example, when carbon element is used as the reducing component, a reaction as presented in the following Equation (2) occurs. Thus, the valuable metals in the recovery object can be reduced into elemental metals (metallic Ni, metallic Co).

$${LiNi}_{x} {Co}_{y} {Mn}_{z} {O}_{δ} + {C}_{1 / 2 δ} = Li + x Ni + y Co + z Mn + 1 / 2 {δCO}_{2} \qquad ( 2 )$$

The heating temperature in this step is preferably 600° C. or higher, more preferably 650° C. or higher, even more preferably 700° C. or higher, particularly preferably 750° C. or higher. There is a tendency that, as the heating temperature increases, the elemental metals of the valuable metals are more easily produced. On the other hand, from the viewpoint of reduction of valuable metals, the upper limit of the heating temperature may be 1500° C. or lower, 1400° C. or lower, or 1300° C. or lower without any particular limitation. In terms of decreasing the cost required for the heat treatment or the like, the upper limit of the heating temperature is preferably 1200° C. or lower, more preferably 1100° C. or lower, particularly preferably 1000° C. or lower.

In this step, it is preferable to heat the recovery object while feeding an inert gas such as argon and nitrogen. Thereby, oxygen element can be properly prevented from being fed to the recovery object to further enhance the rapid reduction of the valuable metals. The term “inert atmosphere” in this specification refers to a heating atmosphere mainly containing the above-described inert gas. In other words, the heating atmosphere in this step is not limited to a completely inert atmosphere with 100% inert gas content (0% oxygen element content), but may contain a trace amount of oxygen element. Specifically, the heating atmosphere in this step only needs to contain 5% or less (preferably 3% or less, more preferably 1% or less, even more preferably 0.5% or less, particularly preferably 0.1% or less) of oxygen element. With such a trace amount of oxygen element, the valuable metals in the recovery object can be reduced into elemental metals even if oxygen element is contained in the heating atmosphere.

### (2) Sorting Step S20

As illustrated in FIG. 3, in the manufacture method according to this embodiment, the sorting step S20 is conducted after the roasting step S10. In this step, each component in the recovery object after the roasting is sorted using a sieve. For example, when the process end material of the positive electrode plate 30 is to be recovered, the positive electrode core 32 should be sorted from the process end material using a sieve and removed from the recovery object. When the electrode body 20 is to be recovered, in addition to the positive electrode core 32, the negative electrode plate 40 should also be removed from the recovery object. Furthermore, when the lithium ion secondary battery 1 is to be recovered, in addition to the above-described positive electrode core 32 and negative electrode plate 40, the case 10 should also be removed from the recovery object. Thus, the content of impurities (Al, Cu, etc.) in the recovery object is decreased, contributing to improvement of the recovery efficiency of the valuable metals (Co, Ni).

In this step, the recovery object may be crushed as necessary. Thereby, the sorting efficiency of each component can be improved. For example, when the lithium ion secondary battery 1 is to be recovered, the case 10 and the electrode body 20 should be crushed. This facilitates removal of the case 10, the positive electrode core 32, and the negative electrode plate 40 from the recovery object.

The sorting step S20 is not intended to completely remove impurities such as Al and Cu from the recovery object. As described later in detail, even if impurities remain in the recovery object, impurities can be sufficiently removed in subsequent steps (acid exudation step S30, neutralization deposition step S40, etc.). That means, this step may be arbitrarily omitted as necessary. For example, when using a recovery object containing a small amount of impurities (process end material of positive electrode plate 30, etc.), valuable metals can be efficiently recovered even if this step is omitted.

### (3) Acid Exudation Step S30

Subsequently, in the acid exudation step S30, the recovery object after the heating step S15 (sorting step S20) is immersed in an acid liquid. Thereby, valuable metals (Li, Ni, Co, Mn) in the recovery object are dissolved in the acid liquid. In this step, in addition to valuable metals, other metal materials (Cu, Al, etc.) are dissolved in the acid liquid in some cases. That means, the solution (metal solution) after the acid exudation will contain metal elements such as Li, Al, Cu, Co, Ni, and Mn. For the acid exudation procedure, any conventionally known procedure can be adopted without any particular limitation. As an example, the acid liquid used in this step is preferably at pH −1.5 to 1.5 (more preferably −0.5 to 0.5). This pH allows the metal components in the recovery object to be suitably dissolved. Specific examples of the acid liquid include inorganic acids such as sulfuric acid, nitric acid, hydrochloric acid, and phosphoric acid, as well as organic acids such as citric acid, ascorbic acid, oxalic acid, and acetic acid. In this step, it is preferable that the metal solution after the acid exudation is subjected to a filtration treatment. Thereby, undissolved components (carbon components etc.) can be efficiently removed. The temperature of the acid liquid is preferably 50° C. or higher (more preferably 55° C. or higher, particularly preferably 60° C. or higher). Thus, the acid exudation step S30 can be shortened. The upper limit temperature of the acid liquid may be 90° C. or lower, 85° C. or lower, or 80° C. or lower without any particular limitation.

In the conventional recovery techniques, the recovery object after roasting has contained a large amount of valuable metal oxides (nickel (II) oxide, cobalt (II) oxide, etc.). For this reason, in the conventional acid exudation step, it was necessary to set a condition that allows appropriate dissolution of these oxides. However, if the acid exudation step is conducted under a condition that allows dissolution of valuable metal oxides, a large amount of metal materials (Cu etc.) other than valuable metals may also be dissolved in the acid liquid. In this case, a large amount of impurities will contaminate the metal solution after the acid exudation step, resulting in complicated separation treatment, lowered valuable metal recovery ratio, or the like. In contrast, in the manufacture method according to this embodiment, the valuable metals are reduced into elemental metals (metallic nickel, metallic cobalt, etc.) in the roasting step S10. These elemental metals have a higher acid solubility than of other metal materials. Thus, in the acid exudation step S30 according to this embodiment, the valuable metals can be properly dissolved before Cu is dissolved.

### (4) Neutralization Deposition Step S40

In this step, a neutralizer is added to the metal solution obtained in the acid exudation step S30. Thereby, Al hydroxide (Al(OH)₃) is precipitated and deposited. As a result, almost Al can be removed from the metal solution containing Li, Al, Cu, Co, Ni, Mn, and the like. As the neutralizer used in this step, an alkaline solution at pH 11 to 15 (preferably pH 12 to 14) can be used. Specific examples of the neutralizer include a sodium hydroxide aqueous solution, calcium hydroxide, and ammonia. Also in this step, it is preferable to filter the metal solution after deposition of Al(OH)₃. Thus, Al(OH)₃ can be efficiently removed from the metal solution.

### (5) Solvent Extraction Step S50

In this step, each of Co, Ni, and Mn is extracted from the metal solution using a solvent extraction method. Thereby, a Co solution, an Ni solution, and an Mn solution can be each prepared. Also in this step, impurities (Al etc.) remaining in the metal solution can be separated. Specifically, the solvent extraction step S50 according to this embodiment includes an Mn extraction step S51, a Co extraction step S52, and an Ni extraction step S53, as illustrated in FIG. 5. Each step will be specifically explained below.

### (a) Mn Extraction Step S51

In this step, an organic solvent (first extractant) with a high extractability for Mn and a low extractability for Li, Al, Cu, Co, and Ni is added to the metal solution. As the first extractant, a phosphoric acid ester-based extracting agent, an oxime-based extracting agent, or the like can be used. Specific Examples of the phosphoric acid ester-based extracting agent include di-2-ethylhexyl phosphoric acid (D2EHPA). Specific examples of the oxime-based extracting agent include 2-hydroxy-5-nonylacetophenoneoxime (LIX84), 5-dodecylsalicylaldoxime (LIX860), and 5-nonylsalicylaldoxime (ACORGA M5640). The first extractant may be prepared by mixing these extracting agents and diluting the mixture. In this step, the metal solution and the first extractant are stirred to suspend the metal in the first extractant. Thereby, Mn in the metal solution dissolves in the first extractant. Then, the solution is left to stand until the two liquids are separated from each other to obtain an Mn solution with Mn dissolved in the first extractant and a metal solution from which Mn has been removed.

In this step, the Mn solution (first extractant containing Mn) after extraction may be subjected to a stripping treatment. In this stripping treatment, the Mn solution (organic phase) and an acidic aqueous solution are first stirred and mixed using a mixer or the like. Then, the mixture was allowed to stand until the two liquids are separated from each other to obtain an aqueous Mn solution with Mn dissolved in the acidic aqueous solution. Examples of the acidic aqueous solution used for the stripping treatment include sulfuric acid and hydrochloric acid (particularly sulfuric acid).

### (b) Co Extraction Step S52

In this step, an organic solvent (second extractant) with a high extractability for Co and a low extractability for Li, Al, Cu, and Ni is added to the metal solution. Thereby, Co is separated from the metal solution, and a Co solution with Co dissolved in the second extractant can be obtained. Specific examples of the second extractant include phosphonate esters such as 2-ethylhexyl (2-ethylhexyl) phosphonate (PC-88A). Also, the Co solution (second extractant containing Co) after the extraction may be subjected to a stripping treatment to obtain an aqueous Co solution. Since the stripping procedure has been already explained above, repeated explanations are omitted.

### (c) Ni Extraction Step S53

In this step, an organic solvent (third extractant) with a high extractability for Ni and a low extractability for Li, Al, and Cu is added to the metal solution. Thereby, Ni is separated from the metal solution, and a Ni solution with Ni dissolved in the third extractant can be obtained. Specific examples of the third extractant include carboxylic acid-based extracting agents such as neodecanoic acid and naphthenic acid. Also, the Ni solution (third extractant containing Ni) after the extraction may be subjected to a stripping treatment to obtain an aqueous Ni solution. Since the stripping procedure has been already explained above, repeated explanations are omitted.

### (6) NCM Crystallization Step S60

In this step, a metal compound crystal is precipitated from each of the Co solution, Ni solution, and Mn solution. In this step, a conventionally known crystallization treatment can be adopted without any particular limitation. For example, if the stripping treatment has been conducted in each of the steps from the Mn extraction step S51 to the Ni extraction step S53, an aqueous mixture is prepared by mixing the Co solution, Ni solution, and Mn solution. Then, the pH of this mixture is adjusted to be alkaline. Thereby, a metal compound crystal can be precipitated. In the preparation of the mixture, each mixing ratio of the Co solution, Ni solution, and Mn solution should be changed as necessary. Then, in the pH adjustment, the mixture is dripped into a reaction tank together with an alkaline solution (ammonia water, sodium hydroxide aqueous solution). Thus, a spherical NiCoMn hydroxide (NCM precursor) can be crystallized.

### (7) Li Crystallization Step S70

In the Li crystallization step S70, an Li compound crystal is precipitated from the metal solution after the solvent extraction step S50. In this step, any conventionally known crystallization treatment can be adopted without any particular limitation. For example, in this step, sodium carbonate should be added to the metal solution. Thereby, a lithium carbonate (Li₂CO₃) crystal can be precipitated. Note that the Li compound produced in this step is not limited to lithium carbonate. For example, lithium hydroxide (LiOH) may be produced as the Li compound as necessary. In the production of lithium hydroxide, lithium carbonate precipitated from the metal solution is first dissolved (or suspended) in a predetermined solvent. Then, calcium hydroxide is added to this solution. Subsequently, the solvent is evaporated off as necessary. Thus, a lithium hydroxide crystal can be precipitated.

### (8) Active Material Production Step S80

In this step, a battery material (positive electrode active material) is produced using the metal compound obtained in the NCM crystallization step S60 and the Li compound obtained in the Li crystallization step S70. Specifically, NiCoMn hydroxide (NCM precursor) and the Li compound (Li₂CO₃ etc.) are mixed and baked to manufacture a positive electrode active material (lithium transition metal composite oxide) for lithium ion secondary batteries.

The method for manufacturing the battery material according to this embodiment has been explained above. As described above, in the manufacture method according to this embodiment, the roasting step S10 is conducted in a state that the recovery object contains a large amount of reducing component and no oxygen element is fed from the outside. Thereby, the valuable metal oxides in the recovery object are rapidly reduced into elemental metals. Since the elemental metals of the valuable metals have a high acid-solubility, they can be easily dissolved in the acid liquid before impurities such as Cu are dissolved, in the acid exudation step S30. Thus, impurities in the metal solution can be decreased, contributing to improvement of the recovery ratio of the valuable metals such as Co and Ni.

### 3. Other Embodiments

One embodiment of the technology disclosed herein has been explained above. The technology disclosed herein is not limited to the embodiment described above but includes other embodiments with variously-changed configurations. Other examples of embodiments of the technology disclosed herein will be explained below.

(1) Each Step after Roasting Step

In the manufacture method according to the embodiment described above, the steps from the sorting step S20 to the active material production step S80 are conducted after the roasting step S10. However, the explanation on the embodiment described above is not intended to limit the steps after the roasting step. That means, in the manufacture method disclosed herein, steps after the roasting step can be arbitrarily added, deleted, and changed as necessary.

### (a) Omission of Solvent Extraction Step

For example, according to the manufacture method disclosed herein, the solvent extraction step S50 can be omitted. Specifically, as described above, the technology disclosed herein makes it possible to suppress dissolution of Cu in the acid exudation step S30. Thereby, the metal solution after the acid exudation will mainly contain Li, Al, Ni, Co, and Mn. If it is possible to properly separate Al from this metal solution and then separately recover Li, the solution can contain valuable metals (Ni, Co, Mn) at high purity. In this case, the mixture of valuable metals used for the NCM crystallization step S60 can be obtained without conducting the solvent extraction step S50. Al can be sufficiently separated from the metal solution by the neutralization deposition step S40 described above. On the other hand, as an example of a means for recovering Li, the following means can be used. When conducting the roasting step S10, a non-metal chlorine compound (HCl etc.) is added to the recovery object for the roasting. Thus, Li in the recovery object reacts with the non-metal chlorine compound to produce LiCl. Subsequently, a water exudation step is conducted, in which the recovery object after the roasting is immersed in water. Since the above-described LiCl is a water-soluble compound, Li can be recovered simply by bringing the recovery object into contact with water.

### (b) Modification of Solvent Extraction Step

The specific treatment procedure in the solvent extraction step S50 can be modified as appropriate. For example, the solvent extraction step S50 according to the embodiment described above includes the Mn extraction step S51, the Co extraction step S52, and the Ni extraction step S53. Thereby, the Co solution, Ni solution, and Mn solution can be separately extracted. However, in the solvent extraction step S50, a plurality of valuable metals may be simultaneously extracted. For example, an organic solvent with a high extractability for Ni and Co and a low extractability for Li, Al, and Cu should be added to the metal solution after the Mn extraction. Thus, Ni and Co can be simultaneously extracted. When a plurality of valuable metals are simultaneously extracted in this way, the producibility can be improved by shortening the process.

### (c) Addition of Li Separation Step

The metal solution after the solvent extraction step S50 may be subjected to an Li separation step. Specifically, the metal solution after the solvent extraction step S50 contains Li as a main component. However, this metal solution may contain, in addition to Li, Cu that has not been removed in the acid exudation step S30, Al that has not been removed in the neutralization deposition step S40, and the like. In the Li separation step, Cu and Al are removed from the metal solution. Thus, a high-purity Li compound can be obtained in the Li crystallization step S70. The means for preparing the Li solution is not particularly limited, and any conventionally known means such as solvent extraction and ion exchange should be adopted as appropriate.

### (d) Addition of Li Concentration Step

The metal solution after the Li separation step may be subjected to a Li concentration step. In this Li concentration step, the Li solution is heated to evaporate the solvent. Thereby, a high concentration Li solution can be obtained, so that the crystallization efficiency in the Li crystallization step S70 can be improved. This Li concentration step may be conducted for a metal solution that has not subjected to the Li separation step. For example, if impurities (Cu, Al) are sufficiently removed between the acid exudation step S30 and the solvent extraction step S50, only the Li concentration step may be conducted without the Li separation step. Also in this case, a high concentration Li solution can be obtained.

### (e) Modification of NCM Crystallization Step

In the above embodiment, the mixture of Co solution, Ni solution, and Mn solution has been subjected to the NCM crystallization step S60. Thereby, the NiCoMn hydroxide can be crystallized as a metal compound containing Co, Ni, and Mn. However, in the NCM crystallization step, each metal compound may be separately crystallized from the Co solution, Ni solution, and Mn solution. When stripping is performed with sulfuric acid as described in the above embodiment, a manganese sulfate (MnSO₄) crystal can be precipitated from the Mn solution by removing and cooling the solvent as necessary. Also, a cobalt sulfate (CoSO₄) crystal is precipitated from the Co solution. Furthermore, a nickel sulfate (NiSO₄) crystal is precipitated from the Ni solution. The NCM precursor synthesized from these sulfate crystals can be mixed with the Li compound and baked to produce a battery material (positive electrode active material).

### (2) Reducing Component Used for Roasting Step

Detailed conditions for the roasting step S10 can also be modified as appropriate. For example, in the manufacture method according to the embodiment described above, carbon element is used as the reducing component. However, as described above, the reducing component is not particularly limited as long as it can reduce Ni and Co in the heating step. Examples of the reducing components other than carbon element (C) include metal-based reducing components such as lithium (Li), cesium (Cs), potassium (K), barium (Ba), strontium (Sr), calcium (Ca), sodium (Na), magnesium (Mg), aluminum (Al), titanium (Ti), zirconium (Zr), and manganese (Mn). These metal-based reducing components should be, in a form of sulfite or the like, contained in the recovery object. For example, when calcium sulfite (CaSO₃) is used as a reducing component, the valuable metals are reduced into elemental metals and calcium oxide (CaO) is produced during the heating step. In this case, the threshold value in the determination step is set to a value higher than or equal to a stoichiometric ratio of CaO (1/1). Thereby, the valuable metals in the recovery object can be properly reduced into elemental metals. Examples of the means for measuring the metal-based reducing component in the measurement step S12 include ICP, SEM-EDS analysis, and XRF analysis. The reducing component to be determined in the determination step S13 and the reducing component to be added in the reducing component addition step S14 may be the same or different from each other. For example, if carbon element (C) is determined to be shortage in the determination step S13, calcium sulfite (CaSO₃) may be added in the reducing component addition step S14. Also in this case, the valuable metals can be properly reduced into elemental metals in the heating step S15.

### Test Examples

Test examples related to the technology disclosed herein will be explained below. The contents of the test examples described below are not intended to limit the technology disclosed herein.

### 1. Preparation of Sample

### Example 1

In this test, a mixture of a positive electrode plate and a negative electrode plate was used as the recovery object, and the recovery object was subjected to a roasting step. Specifically, as the positive electrode plate, a positive electrode core (Al foil) with a surface coated with a positive electrode active material layer was used. As the positive electrode active material in this test, a lithium-nickel-cobalt-manganese composite oxide (LiNi_{1/3}Co_{1/3}Mn_{1/3}O₂) was used. On the other hand, as the negative electrode plate, a negative electrode core (Cu foil) with a surface coated with a negative electrode active material layer was used. As the negative electrode active material, a carbon material (black lead) was used. The mixture of the positive electrode plate and the negative electrode plate was crushed, and passed through a sieve with a mesh size of 500 μm to prepare a powder. This powder was used as a test sample.

Subsequently, a part of the test sample was taken out and dissolved in sulfuric acid. Then, the solution was subjected to ICP, and the total quantity M of Ni, Co, and Mn was measured. Based on the composition of the positive electrode active material (LiNi_{1/3}Co_{1/3}Mn_{1/3}O₂), the quantity twice the total quantity M was defined as a quantity N of oxygen element (N=2M). In this test, a part of the test sample was also subjected to a thermogravimetric-differential thermal analysis (TG-DTA). In this thermogravimetric-differential thermal analysis, the test sample was heated under ambient atmosphere at 800° C. In this analysis, a temperature increase rate from normal temperature (20° C.) to 800° C. was set to 5° C./min. The amount of carbon in the test sample was measured by this analysis. Then, it was determined whether or not the measured quantity ratio between oxygen element and carbon element (C/O ratio) was higher than a stoichiometric ratio of CO₂ (1/2). As a result, in Example 1, the C/O ratio was 1/2 or higher.

Subsequently, in Example 1, the test sample was roasted under an inert atmosphere. Specifically, the test sample was put into an electric furnace, and the furnace temperature was increased to 600° C. while feeding Ar gas. At this time, a temperature increase rate was set to 5° C./min. The sample was roasted for 5 hours while maintaining the furnace temperature at 600° C. Subsequently, the furnace temperature was decreased to 50° C., and then the test sample was recovered.

### Examples 2 to 8

In Examples 2 to 8, at least one of the heating temperature, the heating atmosphere, and the quantity ratio (C/O) of the test sample was changed from Example 1. The conditions for each example are listed in Table 1. In Examples 2 to 8, the test sample preparation and roasting steps were conducted according to the same procedures as in Example 1 except for the conditions presented in Table 1.

### 2. Evaluation Test

### (1) XRD Analysis

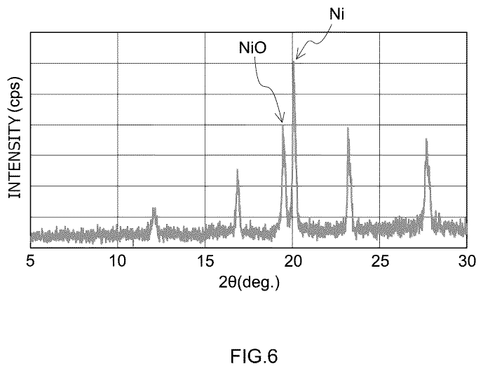

The test sample after the roasting was subjected to an X-ray diffraction (XRD) analysis using an Mo radiation source to evaluate a state of Ni element in the test sample. Specifically, as presented in FIG. 6 (XRD chart of Example 3), the test sample after the roasting shows each peak at around 19° and 20°. Among these peaks, a peak attributed to Ni oxide (NiO peak) can be observed at around 19°, and on the other hand, a peak attributed to elemental metal Ni (Ni peak) can be observed at around 20°. In this test, a peak intensity ratio of the Ni peak relative to the NiO peak (Ni/NiO) was calculated. If this peak intensity ratio was lower than 1, the produced sample was evaluated as NiO-dominated. On the other hand, if the peak intensity ratio was 1 or higher, the produced sample was evaluated as Ni-dominated. The results are presented in Table 1.

In the XRD analysis, each state of Ni and Co in the test sample was also evaluated. Specifically, a sample showing only the NiO peak in the above XRD chart was considered to be “NiO-dominated (“NiO” in Table 1). A sample showing both the NiO and Ni peaks observed was considered to be “mixture of NiO and Ni (“NiO+Ni” in Table 1)”. A sample showing only the Ni peak was considered to be “Ni-dominated (“Ni” in Table 1)”. Also, the state of the remaining metal element (Co) in the test sample after the roasting was analyzed according to the same procedure as for the above-described evaluation of the Ni state. The results are presented in Table 1.

### (2) Recovery Ratio in Acid Exudation

The test sample after the roasting was subjected to acid exudation, and an exudation ratio of each metal element (Ni, Co, Cu) was calculated. Specifically, the test sample after the roasting was first added to 1 mol/L of sulfuric acid (H₂SO₄). Then, the sample was stirred at a stirring speed of 500 rpm for 6 hours while maintaining the temperature of the acid liquid at normal temperature (25° C.). Subsequently, the metal solution after the dissolution was filtered, and then subjected to ICP. By the ICP, each quantity of Ni, Co, and Cu in the metal solution was measured. An exudation ratio of each metal element was calculated based on the following Equation (3). The “quantity before acid exudation” in Equation (3) refers to a value calculated by measuring and grasping a quantity of the sample per 1 g by ICP analysis and multiplying the grasped quantity by a weight of the sample added to the acid.

$$Exudation ratio = ( quantity in metal solution / quantity before acid exudation ) \times 100 \qquad ( 3 )$$

TABLE 1

| | Recovery condition | | | Evaluation test | | | | | |
|---|---|---|---|---|---|---|---|---|---|
| | Heating | | | XRD analysis | | | | | |
| | temperature | Heating | C/O | Peak intensity | | | Exudation ratio (%) | | |
| | (° C.) | atmosphere | ratio | ratio | Ni | Co | Ni | Co | Cu |
| Example 1 | 600 | Ar | ≥1/2 | NiO- | NiO + Ni | CoO + Co | 61 | 70 | 10 |
| | | | | dominated | | | | | |
| Example 2 | 650 | Ar | ≥1/2 | Ni-dominated | NiO + Ni | CoO + Co | 86 | 89 | <1 |
| Example 3 | 700 | Ar | ≥1/2 | Ni-dominated | NiO + Ni | CoO + Co | 90 | 95 | <1 |
| Example 4 | 750 | Ar | <1/2 | NiO- | NiO | CoO | 65 | 72 | 3 |
| | | | | dominated | | | | | |
| Example 5 | 750 | Ar | ≥1/2 | Ni-dominated | Ni | Co | 94 | 98 | <1 |
| Example 6 | 800 | Atmosphere | ≥1/2 | NiO- | NiO | CoO | 45 | 46 | 7 |
| | | | | dominated | | | | | |
| Example 7 | 1000 | Ar | <1/2 | NiO- | NiO + Ni | CoO + Co | 70 | 75 | <1 |
| | | | | dominated | | | | | |
| Example 8 | 1000 | Ar | ≥1/2 | Ni-dominated | Ni | Co | 93 | 99 | <1 |

As presented in Table 1, in Example 6, the Ni and Co exudation ratios were significantly decreased. This may be because most of the valuable metals in the recovery object were oxidized as a result of roasting in ambient atmosphere, making the valuable metals difficult to dissolve in the acid liquid at a low temperature of 25° C. On the other hand, in Example 7, the Ni and Co exudation ratios were significantly improved compared to Example 6. As a result of analyzing the sample of Example 7, it was found that most of the valuable metals (Ni, Co) had been reduced into elemental metals. This indicated that the roasting in a state where the recovery object contains a large amount of reducing component (carbon) and no oxygen element is fed from the outside could contribute to improvement of the Ni and Co recovery ratios. Comparison between Examples 1 to 3, 5, and 8 showed a tendency that, as the heating temperature was increased, the proportion of the elemental metals in the recovery object after the roasting increased, and the exudation ratio in the acid exudation was improved.

As described above, the technologies disclosed herein have been explained in detail, but these technologies are merely examples and are not intended to limit claims. The technologies described in claims include various variations and modifications of the specific examples illustrated above. That means, the technologies disclosed herein encompass configurations described in the following items 1 to 8.

### <Item 1>

A method for manufacturing a battery material, including:
a preparation step of preparing a recovery object containing at least one of Ni and Co;
a measurement step of measuring a quantity of oxygen element and a quantity of a reducing component contained in the recovery object;
a determination step of determining whether or not a quantity ratio of the reducing component relative to oxygen element is higher than or equal to a threshold value based on a stoichiometric ratio of an oxide of the reducing component;
a reducing component addition step of adding the reducing component to the recovery object when a determined result value in the determination step is lower than the threshold value; and
a heating step of heating the recovery object under an inert atmosphere.

### <Item 2>

The method according to Item 1, in which the reducing component is carbon element, and the threshold value is higher than or equal to a stoichiometric ratio of CO₂.

### <Item 3>

The method according to Item 1 or 2, in which the recovery object is heated at 650° C. to 1000° C. in the heating step.

### <Item 4>

The method according to any one of Items 1 to 3, in which the recovery object is heated under an argon or nitrogen atmosphere in the heating step.

### <Item 5>

The method according to any one of Items 1 to 4, in which a quantity of metal elements in the recovery object is measured and the quantity of oxygen element is calculated based on the quantity of the metal elements.

### <Item 6>

The method according to any one or items 1 to 5, in which the recovery object contains at least one selected from a group consisting of a lithium-nickel composite oxide, a lithium-cobalt composite oxide, a lithium-nickel-manganese composite oxide, a lithium-manganese-cobalt composite oxide, a lithium-nickel-cobalt composite oxide, and a lithium-nickel-manganese-cobalt composite oxide.

### <Item 7>

The method according to any one of Items 1 to 6, further including an acid exudation step of immersing the recovery object after the heating step into an acid liquid.

What is claimed is:

1. A method for manufacturing a battery material, comprising:
a preparation step of preparing a recovery object containing at least one of Ni and Co;
a measurement step of measuring a quantity of oxygen element and a quantity of a reducing component contained in the recovery object;
a determination step of determining whether or not a quantity ratio of the reducing component relative to oxygen element is higher than or equal to a threshold value based on a stoichiometric ratio of an oxide of the reducing component;
a reducing component addition step of adding the reducing component to the recovery object when a determined result value in the determination step is lower than the threshold value; and
a heating step of heating the recovery object under an inert atmosphere.

2. The method according to claim 1, wherein the reducing component is carbon element, and the threshold value is higher than or equal to a stoichiometric ratio of CO₂.

3. The method according to claim 1, wherein the recovery object is heated at 650° C. to 1000° C. in the heating step.

4. The method according to claim 1, wherein the recovery object is heated under an argon or nitrogen atmosphere in the heating step.

5. The method according to claim 1, wherein a quantity of metal elements in the recovery object is measured and the quantity of oxygen element is calculated based on the quantity of the metal elements.

6. The method according to claim 1, wherein the recovery object contains at least one selected from a group consisting of a lithium-nickel composite oxide, a lithium-cobalt composite oxide, a lithium-nickel-manganese composite oxide, a lithium-manganese-cobalt composite oxide, a lithium-nickel-cobalt composite oxide, and a lithium-nickel-manganese-cobalt composite oxide.

7. The method according to claim 1, further comprising an acid exudation step of immersing the recovery object after the heating step into an acid liquid.
